(19) United States
(12) Patent Application Publication
(10) Pub. No.: US 2004/0093398 A1
(43) Pub. Date: May 13, 2004

(54) Method and apparatus for performing dual active scan

(76) Inventors: Zhicheng Tang, Plano, TX (US); Jun Tang, San Jose, CA (US)

Correspondence Address: TEXAS INSTRUMENTS INCORPORATED, P O BOX 655474, M/S 3999, DALLAS, TX, 75265

(21) Appl. No.: 10/289,672

(22) Filed: Nov. 7, 2002

(51) Int. Cl. G06F 15/177

(52) U.S. Cl. 709/220

(57) ABSTRACT

A dual active scan technique (100) helps reduce the problem of losing a preferred Wireless Local Area Network (WLAN) in a congested environment, and also allows the communication device (202) to become aware of other WLANs that may be available for use by a communication device (202). The dual active scan (100) performs an active scan with preferred SSID followed by an active scan with broadcasting SSID.

### FIELD OF THE INVENTION

The present invention relates in general to wireless communications and more particularly, to a method and apparatus for performing a dual active scan in a communication system.

### BACKGROUND OF THE INVENTION

In a wireless communication such as one compliant with the Institute for Electrical and Electronic Engineers (IEEE) 802.11 standard, three types of scan techniques are available to seek a network connection between a communication device (e.g., laptop having a wireless modem, etc.) and the wireless network. The three scan techniques include: active scan, passive scan, and power saving mode scan. The passive scan technique causes the communication device that is attempting to seek a network connection to scan each of its predetermined channels, and monitor all received beacons for network association. Since beacons are sent by a network access point in time intervals of 10 ms to 200 ms, in order to ascertain all existing wireless network information, the communication device has to stay in each channel a fairly long period of time. A scan of 14 channels can take about 30 seconds. The time required to complete a scan using the passive scan technique is too long and not practical for most system users.

In the active scan mode, the communication device can specify the preferred wireless network ID (SSID) in a probe request packet and then it scans all the available channels for that particular SSID. Upon receiving the probe request from the communication device, the network access point replies to the probe request if its SSID matches the one sent by the communication device. Although the active scan mode may help reduce the time required to scan, only the preferred access point replies and therefore the communication device will not become aware of other existing networks, which may be better suited for its needs. Starting with the Microsoft Windows XP operating system (OS), the Windows OS requires knowing all available wireless networks that are available. A device using the Windows XP OS can specify the broadcasting of an SSID in the probe request packet and then can scan all the available channels (referred to herein as active scan with broadcasting SSID). All network access points are supposed to reply back to this request. The device can record all probe response packets and be aware of all existing wireless networks. There is however one problem with this, since in an active scan, the device only stays in a particular channel briefly, if there are several access points in the same channel, it can miss some of the network access points. As such, if for example, there are three or more different wireless networks in the same channel as the preferred wireless network, the device may miss the probe request from the preferred access point he was trying to access. Given the above discussion, there is a need in the art for a scanning method that can help reduce or eliminate some of the problems mentioned above.

### BRIEF DESCRIPTION OF THE DRAWINGS

A more complete understanding of the present invention may be derived by referring to the detailed description and claims when considered in conjunction with the following figures.

FIG. 1 is a flow chart highlighting the steps taken in the dual active scan method in accordance with the invention.

FIG. 2 shows a communication system in accordance with the invention.

### DETAILED DESCRIPTION OF A PREFERRED EMBODIMENT

It should be appreciated that the particular implementations shown and described herein are illustrative of the invention and its best mode and are not intended to otherwise limit the scope of the invention in any way.

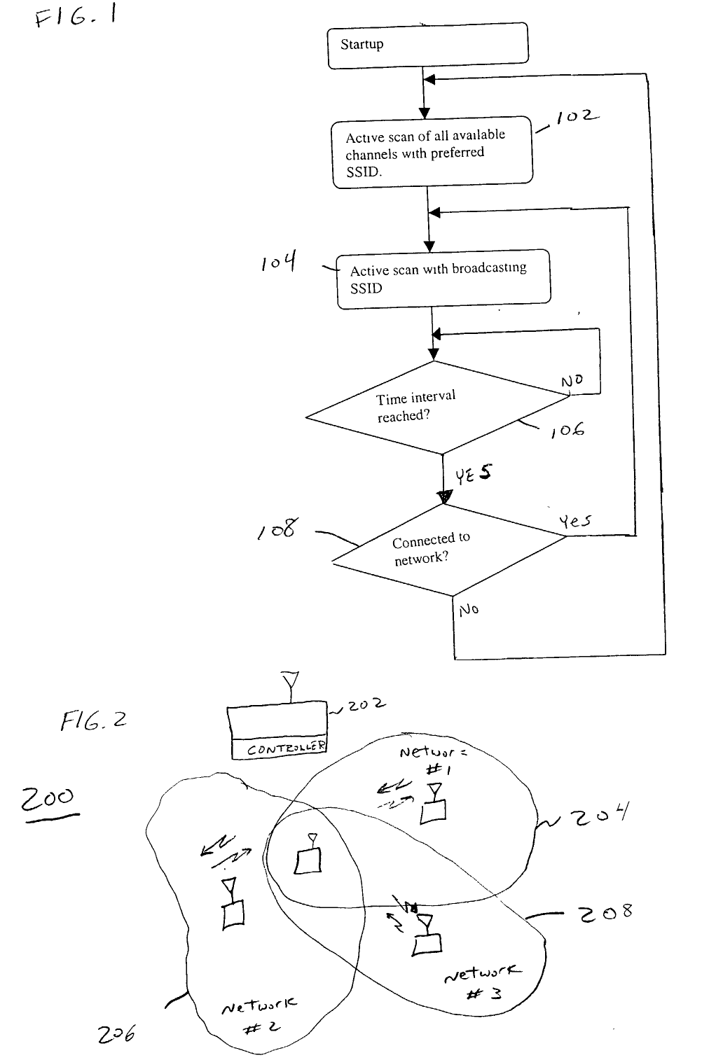

Referring now to FIG. 1, there is shown a flowchart highlighting the scan technique of the preferred embodiment. During power up of the communication device, the device in step 102, will scan all available channels using active scan with preferred SSID to determine if the preferred wireless network is available or not. In subsequent scans, if the device is already connected to the network, the device will only perform an active scan with broadcasting SSID in step 104.

In optional step 106, it is determined if a preset time interval has been reached. This time interval can be decided upon based on system design criteria. This time interval can be used to allow the designer flexibility in terms of how long the scans should be allowed to run. If in step 106, the predetermined time interval has been reached, it is then determined in step 108 if the communication device is connected to a network. If the communication device is not connected to a network, the routine returns to step 102, if however as mentioned before the communication device is connected to a network, the routine proceeds to step 104 and bypasses step 102. In an alternative embodiment, steps 102 and 104 can be switched around, and the communication device can commence by performing an active scan with broadcasting SSID, followed by an active scan with preferred SSID.

Referring now to FIG. 2, there is shown a communication system 200 in accordance with the present invention. Communication device 202 is an electronic device such as a portable computer with wireless modem, a personal digital assistant having wireless communication capabilities, etc. that supports the algorithm shown in FIG. 1. Communication device includes a controller that can execute the scan routine previously described in order to determine which communication network 204, 206 or 208 is best suited for its needs in an efficient manner.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention.

What is claimed is:

1. A scanning method for use by a communication device that operates in a wireless communication system, the scanning method comprising the steps of:
(a) performing an active scan with preferred Service Set Identity (SSID); and
(b) performing an active scan with broadcasting SSID.

2. A method as defined in claim 1, wherein step (b) is performed after step (a).

3. A method as defined in claim 1, wherein step (b) is performed prior to performing step (a).

4. A method as defined in claim 1, wherein the communication system includes one or more communication networks and the method comprising the further step of:
(c) determining if the communication device is connected to one of the one or more communication networks.

5. A method as defined in claim 4, wherein step (c) is performed only after a predetermined time interval has been reached.

6. A method as defined in claim 4, wherein if the communication device is connected to one of the communication networks, step (b) is performed again, otherwise, step (a) is performed again.

7. A method as defined in claim 1, wherein the communication device is compliant with the Institute of Electrical and Electronics Engineers (IEEE) 802.11 wireless local area network standard.

8. A wireless communication device, comprising:
a controller; and
the controller performs:
(a) an active scan with preferred Service Set Identity (SSID); and
(b) an active scan with broadcasting SSID;
in order to locate a communication network for use by the wireless communication device.

9. A wireless communication device as defined in claim 8, wherein if the communication device is already connected to a communication network after (a) and (b) have been performed, the controller only performs (b) again.

10. A wireless communication device as defined in claim 8, wherein the wireless communication device is compliant with the Institute of Electrical and Electronics Engineers (IEEE) 802.11 wireless local area network standard.
